(19) United States
(12) Patent Application Publication
(10) Pub. No.: US 2026/0141908 A1
(43) Pub. Date: May 21, 2026

(54) VOICE SIGNAL DECODING METHOD AND APPARATUS AND ELECTRONIC DEVICE

(71) Applicant: HUAWEI TECHNOLOGIES CO., LTD., Shenzhen (CN)

(72) Inventors: Hongjiang Yu, Shenzhen (CN); Lei Li, Beijing (CN); Zhe Wang, Beijing (CN); Bingyin Xia, Beijing (CN)

(21) Appl. No.: 19/372,522

(22) Filed: Oct. 29, 2025

Related U.S. Application Data
(63) Continuation of application No. PCT/CN2024/100391, filed on Jun. 20, 2024.

(30) Foreign Application Priority Data
Aug. 14, 2023 (CN) 202311022626.8

(51) Int. Cl. G10L 19/22; G10L 19/008; G10L 25/03; G10L 25/30

(52) U.S. Cl. CPC G10L 19/22; G10L 19/008; G10L 25/03; G10L 25/30

(57) ABSTRACT

This disclosure provides a voice signal decoding method and apparatus and an electronic device. An encoding apparatus encodes an original voice signal, to obtain an encoded bitstream. The encoded bitstream includes an acoustic feature encoding result. A decoding apparatus obtains the acoustic feature encoding result in the encoded bitstream, obtains a style feature from the acoustic feature encoding result, obtains an excitation feature, performs style fusion processing on the excitation feature and the style feature, to obtain a fused voice feature, and reconstructs a decoded voice signal based on the voice feature. Because the style feature indicates a voice style of an original voice signal, a voice feature in the original voice signal can be restored from the voice feature obtained by performing style fusion on the excitation feature and the style feature.

### CROSS-REFERENCE TO RELATED APPLICATIONS

This application is a continuation of International Application No. PCT/CN2024/100391, filed on Jun. 20, 2024, which claims priority to Chinese Patent Application No. 202311022626.8, filed on Aug. 14, 2023. The disclosures of the aforementioned applications are hereby incorporated by reference in their entireties.

### TECHNICAL FIELD

Embodiments of this disclosure relate to the field of audio decoding technologies, and in particular, to a voice signal decoding method and apparatus and an electronic device.

### BACKGROUND

Quality of a voice synthesized according to a conventional voice coding algorithm at a low bit rate has entered a bottleneck period. A deep neural network (DNN)-based algorithm is applied to the voice signal processing field. In other words, there is a DNN-based voice coding system, which mainly aims to improve performance of the conventional voice coding algorithm based on a strong learning capability of a DNN.

The DNN-based voice coding system may be mainly classified into two types: a neural vocoder-based system and an end-to-end neural codec system. The neural vocoder-based system extracts an acoustic feature via an encoder, quantizes the acoustic feature, and then performs voice synthesis on a quantized acoustic feature via a neural vocoder, to obtain an encoded voice signal. The neural vocoder-based system has an advantage of a low bit rate usually as low as 1.6 kilobits per second (kbps). However, because the conventional coding algorithm is directly reused in both the encoder and the quantization step, only parameters of a decoder can be adjusted through big data training. As a result, quality of a decoded voice is limited.

In the neural codec system, both an encoder and a decoder are implemented via the DNN, a specific solution for implementing feature extraction of the encoder does not need to be designed, and network parameters are adjusted in an end-to-end joint training manner. However, when a voice output through voice encoding has a low bit rate, a voice signal obtained through decoding has poor performance.

### SUMMARY

This disclosure provides a voice signal decoding method and apparatus and an electronic device.

According to a first aspect, an embodiment of this disclosure provides a voice signal decoding method. The method includes: obtaining an acoustic feature encoding result in an encoded bitstream; obtaining a style feature from the acoustic feature encoding result, where the style feature indicates a voice style of an original voice signal; in response to an obtained excitation feature, performing style fusion processing on the style feature and the excitation feature to obtain a fused voice feature; and generating a decoded voice signal based on to the fused voice feature.

In the foregoing implementation solution, an encoding apparatus encodes the original voice signal, to obtain the encoded bitstream. The encoded bitstream includes the acoustic feature encoding result. A decoding apparatus obtains the acoustic feature encoding result in the encoded bitstream, and obtains the style feature from the acoustic feature encoding result. The decoding apparatus obtains the excitation feature, performs style fusion processing on the excitation feature and the style feature, to obtain the fused voice feature, and reconstructs the decoded voice signal based on the voice feature. Because the style feature indicates the voice style of the original voice signal, a voice feature in the original voice signal can be restored from the voice feature obtained by performing style fusion on the excitation feature and the style feature. In this way, quality of the decoded voice signal reconstructed based on the fused voice feature can be effectively improved in comparison with that of a decoded voice signal obtained without style fusion.

In a possible implementation, the method further includes: obtaining the excitation feature via an excitation network. In the foregoing implementation solution, the excitation network may generate the excitation feature, thereby resolving a problem in obtaining the excitation feature.

In a possible implementation, the excitation network includes an excitation signal generation model and a first convolution module. Obtaining the excitation feature via the excitation network includes: generating an excitation signal via the excitation signal generation model; and performing convolution processing on the excitation signal via the first convolution module, to obtain the excitation feature. In the foregoing implementation solution, the excitation signal generation model and the first convolution module are used, so that the excitation feature can be generated by using a simple device structure. This simplifies a process of generating the excitation feature.

In a possible implementation, the excitation network further includes a short-time Fourier transform module. Obtaining the excitation feature via the excitation network further includes: extracting a time-frequency domain feature from the excitation signal via the short-time Fourier transform module; and performing convolution processing on the excitation signal via the first convolution module includes: performing convolution processing on the time-frequency domain feature via the first convolution module. In the foregoing implementation solution, the first convolution module performs convolution on the time-frequency domain feature, to output the excitation feature. The excitation feature and the acoustic feature have a same dimension, to simplify calculation.

In a possible implementation, obtaining the style feature from the acoustic feature encoding result includes: obtaining the style feature from the acoustic feature encoding result via a style network. In the foregoing implementation solution, the style network may obtain the style feature, and the decoding apparatus may input the style feature into a generator in the decoding apparatus, and reconstruct a voice signal via the generator. This resolves a problem in obtaining the style feature.

In a possible implementation, the style network includes a first upsampling module and a second convolution module. Obtaining the style feature from the acoustic feature encoding result via the style network includes: performing upsampling on the acoustic feature encoding result via the first upsampling module, to obtain an acoustic feature upsampling result; and performing convolution processing on the acoustic feature upsampling result via the second convolution module, to obtain the style feature. In the foregoing implementation solution, the first upsampling module and the second convolution module are used, so that the style feature can be generated by using a simple device structure. This simplifies a process of generating the style feature.

In a possible implementation, the style network includes a first upsampling module, a first convolution layer, and a second convolution layer. Obtaining the style feature from the acoustic feature encoding result via the style network includes: performing upsampling on the acoustic feature encoding result via the first upsampling module, to obtain an acoustic feature upsampling result; inputting the acoustic feature upsampling result into the first convolution layer for convolution processing, to obtain a style sub-feature; inputting the style sub-feature into the first upsampling module for upsampling, to obtain a style upsampling result; and inputting the style upsampling result into the second convolution layer for convolution processing, to obtain the style feature. In the foregoing implementation solution, the first convolution layer and the second convolution layer are used, so that the style feature can be generated by using a simple device structure. This simplifies a process of generating the style feature, and resolves a problem in generating the style feature during multi-layer stacking of the convolution module.

In a possible implementation, performing style fusion processing on the style feature and the excitation feature, to obtain the fused voice feature includes: separately inputting the style feature and the excitation feature into a generator, and performing style fusion processing on the style feature and the excitation feature via the generator, to obtain the fused voice feature. In the foregoing implementation solution, the generator in the decoding apparatus separately receives the style feature and the excitation feature, and then, the generator performs style fusion processing on the style feature and the excitation feature, to obtain the fused voice feature. The fused voice feature carries a voice style of the original voice signal, and therefore signal quality of the reconstructed voice signal can be improved.

In a possible implementation, the generator includes a second upsampling module, a style fusion module, a gating module, and a third convolution module. Performing style fusion processing on the style feature and the excitation feature via the generator, to obtain the fused voice feature includes: performing upsampling processing on the excitation feature via the second upsampling module, to obtain a first signal feature; performing linear modulation on the first signal feature and the style feature via the style fusion module, to obtain a second signal feature, and processing the second signal feature via the gating module, to obtain a third signal feature; and performing convolution processing on the third signal feature via the third convolution module, to obtain the fused voice feature. In the foregoing implementation solution, the second upsampling module, the style fusion module, the gating module, and the third convolution module are used, so that style fusion can be implemented by using a simple device structure. This simplifies a style fusion processing process, and resolves a problem existing when the generator synthesizes the excitation feature into the high-quality decoded voice signal.

In a possible implementation, the style fusion module includes a first style fusion submodule and a second style fusion submodule. The gating module includes a first gating submodule and a second gating submodule. Performing linear modulation on the first signal feature and the style feature via the style fusion module, to obtain the second signal feature, and processing the second signal feature via the gating module, to obtain the third signal feature include: performing linear modulation on the first signal feature and the style feature via the first style fusion submodule, to obtain a first modulation result; processing the first modulation result via the first gating submodule, to obtain a first gating result; performing linear modulation on the first gating result and the style feature via the second style fusion submodule, to obtain a second modulation result; and processing the second modulation result via the second gating submodule, to obtain the third signal feature. In the foregoing implementation solution, the first style fusion submodule, the second style fusion submodule, the first gating submodule, and the second gating submodule are used, so that the third signal feature can be generated by using a simple device structure. This simplifies a process of generating the signal feature, and resolves a problem in generating the third signal feature during multi-layer stacking of the style fusion module and the gating module.

In a possible implementation, the method further includes: inputting the decoded voice signal and the original voice signal into a discriminator, and recognizing the decoded voice signal and the original voice signal via the discriminator. In the foregoing solution, when a voice coding system performs model training via a generative adversarial network, the discriminator is configured to distinguish between the original voice signal and the decoded voice signal in a training process, to improve training accuracy.

According to a second aspect, an embodiment of this disclosure provides a voice signal decoding apparatus. The apparatus includes:
an obtaining module, configured to obtain an acoustic feature encoding result in an encoded bitstream;
a style feature obtaining module, configured to obtain a style feature from the acoustic feature encoding result, where the style feature indicates a voice style of an original voice signal;
a style fusion module, configured to, in response to an obtained excitation feature, perform style fusion processing on the style feature and the excitation feature to obtain a fused voice feature; and
a signal generation module, configured to generate a decoded voice signal based on the fused voice feature.

In the foregoing implementation solution, an encoding apparatus encodes the original voice signal, to obtain the encoded bitstream. The encoded bitstream includes the acoustic feature encoding result. A decoding apparatus obtains the acoustic feature encoding result in the encoded bitstream, and obtains the style feature from the acoustic feature encoding result. The decoding apparatus obtains the excitation feature, performs style fusion processing on the excitation feature and the style feature, to obtain the fused voice feature, and reconstructs the decoded voice signal based on the voice feature. Because the style feature indicates the voice style of the original voice signal, a voice feature in the original voice signal can be restored from the voice feature obtained by performing style fusion on the excitation feature and the style feature. In this way, quality of the decoded voice signal reconstructed based on the fused voice feature can be effectively improved in comparison with that of a decoded voice signal obtained without style fusion.

The voice signal decoding apparatus in the second aspect may perform the steps in any one of the first aspect and the implementations of the first aspect. Details are not described herein again.

Any one of the second aspect and the implementations of the second aspect corresponds to any one of the first aspect and the implementations of the first aspect. For technical effect corresponding to any one of the second aspect and the implementations of the second aspect, refer to the technical effect corresponding to any one of the first aspect and the implementations of the first aspect. Details are not described herein again.

According to a third aspect, an embodiment of this disclosure provides an electronic device, including a memory and a processor. The memory is coupled to the processor. The memory stores program instructions. When the program instructions are executed by the processor, the electronic device is enabled to perform the voice signal decoding method in any one of the first aspect or the possible implementations of the first aspect.

Any one of the third aspect and the implementations of the third aspect corresponds to any one of the first aspect and the implementations of the first aspect. For technical effect corresponding to any one of the third aspect and the implementations of the third aspect, refer to the technical effect corresponding to any one of the first aspect and the implementations of the first aspect. Details are not described herein again.

According to a fourth aspect, an embodiment of this disclosure provides a chip, including one or more interface circuits and one or more processors. The interface circuit is configured to: receive a signal from a memory of an electronic device, and send the signal to the processor. The signal includes computer instructions stored in the memory. When the processor executes the computer instructions, the electronic device is enabled to perform the voice signal decoding method in any one of the first aspect or the possible implementations of the first aspect.

Any one of the fourth aspect and the implementations of the fourth aspect corresponds to any one of the first aspect and the implementations of the first aspect. For technical effect corresponding to any one of the fourth aspect and the implementations of the fourth aspect, refer to the technical effect corresponding to any one of the first aspect and the implementations of the first aspect. Details are not described herein again.

According to a fifth aspect, an embodiment of this disclosure provides a computer-readable storage medium. The computer-readable storage medium stores a computer program. When the computer program is run on a computer or a processor, the computer or the processor is enabled to perform the voice signal decoding method in any one of the first aspect or the possible implementations of the first aspect.

Any one of the fifth aspect and the implementations of the fifth aspect corresponds to any one of the first aspect and the implementations of the first aspect. For technical effect corresponding to any one of the fifth aspect and the implementations of the fifth aspect, refer to the technical effect corresponding to any one of the first aspect and the implementations of the first aspect. Details are not described herein again.

According to a sixth aspect, an embodiment of this disclosure provides a computer program product. The computer program product includes a software program. When the software program is executed by a computer or a processor, the computer or the processor is enabled to perform the voice signal decoding method in any one of the first aspect or the possible implementations of the first aspect.

Any one of the sixth aspect and the implementations of the sixth aspect corresponds to any one of the first aspect and the implementations of the first aspect. For technical effect corresponding to any one of the sixth aspect and the implementations of the sixth aspect, refer to the technical effect corresponding to any one of the first aspect and the implementations of the first aspect. Details are not described herein again.

According to a seventh aspect, an embodiment of this disclosure provides a bitstream storage apparatus. The apparatus includes a receiver and at least one storage medium. The receiver is configured to receive a bitstream. The at least one storage medium is configured to store the bitstream. The bitstream is generated in any one of the first aspect and the implementations of the first aspect.

Any one of the seventh aspect and the implementations of the seventh aspect corresponds to any one of the first aspect and the implementations of the first aspect. For technical effect corresponding to any one of the seventh aspect and the implementations of the seventh aspect, refer to the technical effect corresponding to any one of the first aspect and the implementations of the first aspect. Details are not described herein again.

### BRIEF DESCRIPTION OF DRAWINGS

FIG. 1a is a diagram of an example of an application scenario;

FIG. 1b is a diagram of an example of an application scenario;

FIG. 2 is a diagram of an example of a structure of a voice coding system;

FIG. 3 is a diagram of an example of a structure of another voice coding system;

FIG. 4 is a diagram of an example of a structure of another voice coding system;

FIG. 5 is a diagram of an example of a decoding process;

FIG. 6 is a diagram of an example of a structure of an excitation network;

FIG. 7 is a diagram of an example of a structure of a style network;

FIG. 8 is a diagram of an example of a structure of a second convolution module;

FIG. 9 is a diagram of an example of a structure of a generator;

FIG. 10 is a diagram of an example of a structure of a decoding apparatus;

FIG. 11 is a diagram of an example of a structure of another voice coding system;

FIG. 12a is a diagram of an example of structures of a first style network module and a first generator module in a decoding apparatus;

FIG. 12b is a diagram of an example of structures of an N^{th} style network module and an N^{th} generator module in a decoding apparatus;

FIG. 13 is a diagram of an example of a structure of a voice signal decoding apparatus; and

FIG. 14 is a diagram of an example of a structure of a voice signal decoding apparatus.

### DESCRIPTION OF EMBODIMENTS

The following clearly describes technical solutions in embodiments of this disclosure with reference to accompanying drawings in embodiments of this disclosure. It is clear that the described embodiments are some but not all of embodiments of this disclosure. All other embodiments obtained by a person of ordinary skill in the art based on embodiments of this disclosure without creative efforts shall fall within the protection scope of this disclosure.

The term “and/or” in this specification describes only an association relationship for associated objects and indicates that three relationships may exist. For example, A and/or B may indicate the following three cases: Only A exists, both A and B exist, and only B exists.

In the specification and claims of embodiments of this disclosure, the terms “first”, “second”, and the like are intended to distinguish between different objects but do not indicate a particular order of the objects. For example, a first target object and a second target object are intended to distinguish between different target objects, but are not used to describe a particular order of the target objects.

In embodiments of this disclosure, the word “example”, “for example”, or the like is used to represent giving an example, an illustration, or a description. Any embodiment or design scheme described as an “example” or “for example” in embodiments of this disclosure should not be explained as being more preferred or having more advantages than another embodiment or design scheme. Exactly, use of the word such as “example” or “for example” is intended to present a related concept in a specific manner.

In the descriptions of embodiments of this disclosure, unless otherwise stated, “a plurality of” means two or more than two. For example, a plurality of processing units are two or more processing units, and a plurality of systems are two or more systems.

For clear and brief description of the following embodiments, a brief description of a related technology is first provided.

A sound is a continuous wave generated by an object through vibration. An object that vibrates to produce a sound wave is referred to as a sound source. During propagation of the sound wave through a medium (for example, air, solid, or liquid), an auditory organ of a person or an animal can sense sound.

Features of the sound wave include a tone, intensity, and a timbre. The tone indicates a level of the sound. The intensity indicates volume of the sound. The intensity may also be referred to as loudness or volume. A unit of the intensity is decibel (dB). The timbre is also referred to as sound quality.

A frequency of the sound wave determines a level of the tone. A higher frequency indicates a higher tone. A quantity of times that the object vibrates within one second is referred to as a frequency, and a unit of the frequency is hertz (Hz). A frequency of sound that can be recognized by human ears ranges from 20 Hz to 20000 Hz.

An amplitude of the sound wave determines a level of the intensity. A larger amplitude indicates higher intensity. A shorter distance from the sound source indicates higher intensity.

A waveform of the sound wave determines the timbre. The waveform of the sound wave includes a square wave, a sawtooth wave, a sine wave, a pulse wave, and the like.

Sound may be classified into regular sound and irregular sound based on the features of the sound wave. The irregular sound is sound produced by a sound source through irregular vibration. The irregular sound is, for example, noise that affects people's work, study, rest, and the like. The regular sound is sound produced by a sound source through regular vibration. The regular sound includes a voice and music. When the sound is represented electrically, the regular sound is an analog signal that changes continuously in time-frequency domain. The analog signal may be referred to as an audio signal. The audio signal is an information carrier that carries a voice, music, and sound effect. For example, the audio signal includes a voice signal. A human auditory sense has a capability of distinguishing location distribution of a sound source in space. Therefore, when hearing sound in space, a listener can sense a direction and a location of the sound in addition to a tone, intensity, and a timbre of the sound.

The voice signal in embodiments of this disclosure may include a mono signal, or may include a multi-channel signal. For example, an original voice signal obtained by an encoding apparatus in embodiments of this disclosure may include a scene audio signal. The scene audio signal may be a signal used to describe a sound field. The voice signal may include a higher order ambisonics (HOA) signal (where the HOA signal may include a three-dimensional HOA signal and a two-dimensional HOA signal (which may also be referred to as a planar HOA signal)) and a three-dimensional audio signal. The three-dimensional audio signal may be an audio signal other than the HOA signal in the voice signal.

An acoustic feature is a hidden-layer acoustic feature obtained by the encoding apparatus by mapping the original voice signal. The encoding apparatus inputs the acoustic feature into a quantizer, and compresses the acoustic feature via the quantizer. A compression result generated by the quantizer is referred to as an acoustic feature encoding result.

A style feature is a feature of style information of a voice signal. For example, the style feature indicates a voice style of the original voice signal. In an implementation, the style feature may reflect a phonetic feature. For example, the style feature may reflect at least one feature of voice content, voice energy, and a voice timbre of the voice signal.

In a possible implementation, the style feature is generated by a style network. In embodiments of this disclosure, a decoding apparatus may include the style network. The acoustic feature encoding result output by the quantizer may be sent to the decoding apparatus. The acoustic feature encoding result is input into the style network included in the decoding apparatus. The style network may include a plurality of convolution layers, and the style feature is obtained through mapping via the plurality of convolution layers. In embodiments of this disclosure, the acoustic feature encoding result is no longer directly used as an input of a generator in the decoding apparatus. Instead, the input of the generator is a constant, and the constant input is converted into a target output via the style network based on the style feature. The target is a decoded voice signal.

An excitation feature is used to perform style fusion processing with the style feature, to obtain a fused voice feature. The excitation feature may be generated by an excitation network. For example, after the excitation network generates the excitation feature, the excitation feature is input into the generator in the decoding apparatus. For another example, the decoding apparatus includes the excitation network and the generator, and after the excitation network generates the excitation feature, the excitation feature is sent to the generator.

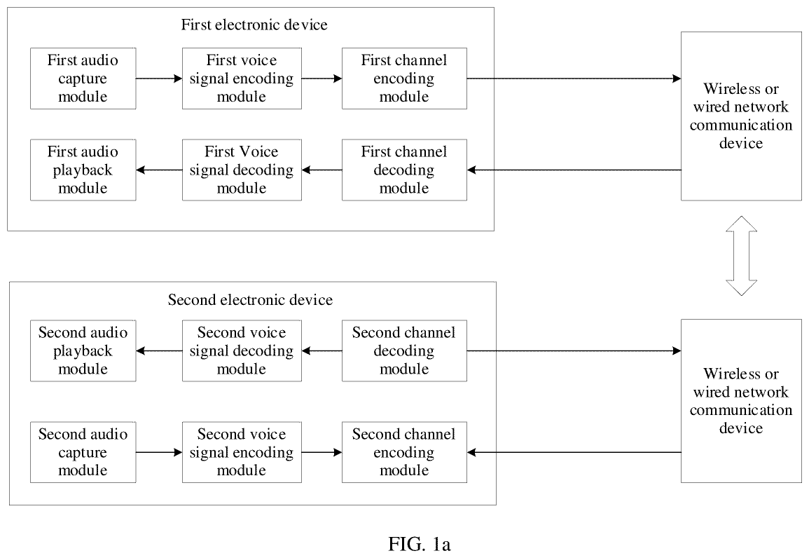

FIG. 1a is a diagram of an example of an application scenario. FIG. 1a shows a voice signal coding scenario.

As shown in FIG. 1a, for example, a first electronic device may include a first audio capture module, a first voice signal encoding module, a first channel encoding module, a first channel decoding module, a first voice signal decoding module, and a first audio playback module. It should be understood that the first electronic device may include more or fewer modules than those shown in FIG. 1a. This is not limited in this disclosure.

As shown in FIG. 1a, for example, a second electronic device may include a second audio capture module, a second voice signal encoding module, a second channel encoding module, a second channel decoding module, a second voice signal decoding module, and a second audio playback module. It should be understood that the second electronic device may include more or fewer modules than those shown in FIG. 1a. This is not limited in this disclosure.

For example, a process in which the first electronic device encodes a voice signal and transmits the encoded voice signal to the second electronic device, and the second electronic device performs decoding and audio playback may be as follows: The first audio capture module may perform audio capture, and output the voice signal to the first voice signal encoding module. Then, the first voice signal encoding module may encode the voice signal, and output a bitstream to the first channel encoding module. Then, the first channel encoding module may perform channel encoding on the bitstream, and transmit the bitstream obtained through channel encoding to the second electronic device via a wireless or wired network communication device. Then, the second channel decoding module of the second electronic device may perform channel decoding on received data, to obtain the bitstream, and output the bitstream to the second voice signal decoding module. Then, the second voice signal decoding module may decode the bitstream, to obtain a reconstructed voice signal, and then output the reconstructed voice signal to the second audio playback module; and the second audio playback module performs audio playback.

It should be understood that a process in which the second electronic device encodes a voice signal and transmits the encoded voice signal to the first electronic device, and the first electronic device performs decoding and audio playback is similar to the foregoing process in which the first electronic device transmits the voice signal to the second electronic device, and the second electronic device performs audio playback. Details are not described herein again.

For example, each of the first electronic device and the second electronic device may include but is not limited to a personal computer, a computer workstation, a smartphone, a tablet computer, a server, a smart camera, a smart car, another type of cellular phone, a media consumption device, a wearable device, a set-top box, and a game console.

For example, this disclosure may be specifically applied to a virtual reality (VR) scenario/an augmented reality (AR). In a possible implementation, the first electronic device is a server, and the second electronic device is a VR device/an AR device. In a possible implementation, the second electronic device is a server, and the first electronic device is a VR device/an AR device.

For example, the first voice signal encoding module and the second voice signal encoding module may be voice signal encoders; and the first voice signal decoding module and the second voice signal decoding module may be voice signal decoders.

For example, when the first electronic device encodes a voice signal, and the second electronic device reconstructs a voice signal, the first electronic device may be referred to as an encoder or an encoding apparatus, and the second electronic device may be referred to as a decoder or a decoding apparatus. When the second electronic device encodes a voice signal, and the first electronic device reconstructs a voice signal, the second electronic device may be referred to as an encoder or an encoding apparatus, and the first electronic device may be referred to as a decoder or a decoding apparatus.

FIG. 1b is a diagram of an example of an application scenario. FIG. 1b shows a voice signal transcoding scenario.

As shown in (1) in FIG. 1b, for example, a wireless or core network device may include a channel decoding module, another audio decoding module, a voice signal encoding module, and a channel encoding module. The wireless or core network device may be configured to perform audio transcoding.

For example, a specific application scenario in (1) in FIG. 1b may be as follows: When a first electronic device is not provided with a voice signal decoding module, and is provided with only another audio encoding module, and a second electronic device is provided with only a voice signal decoding module, and is not provided with another audio decoding module, the wireless or core network device may be used for transcoding, to enable the second electronic device to decode and play back a voice signal encoded by the first electronic device via the another audio encoding module.

Specifically, the first electronic device encodes a voice signal via the another audio encoding module, to obtain a first bitstream, performs channel encoding on the first bitstream, and then sends the first bitstream obtained through channel encoding to the wireless or core network device. Then, the channel decoding module of the wireless or core network device may perform channel decoding, and output, to the another audio decoding module, a first bitstream obtained through channel decoding. Then, the another audio decoding module decodes the first bitstream to obtain a voice signal, and outputs the voice signal to the voice signal encoding module. Then, the voice signal encoding module may encode the voice signal to obtain a second bitstream, and output the second bitstream to the channel encoding module. The channel encoding module performs channel encoding on the second bitstream, and then sends the second bitstream obtained through channel encoding to the second electronic device. In this way, the second electronic device may invoke the voice signal decoding module to decode the second bitstream obtained through channel decoding, to obtain a reconstructed voice signal; and may play back the reconstructed voice signal subsequently.

As shown in (2) in FIG. 1b, for example, a wireless or core network device may include a channel decoding module, a voice signal decoding module, another audio encoding module, and a channel encoding module. The wireless or core network device may be configured to perform audio transcoding.

For example, a specific application scenario in (2) in FIG. 1b may be as follows: When a first electronic device is provided with only a voice signal encoding module, and is not provided with another audio encoding module, and a second electronic device is not provided with a voice signal decoding module, and is provided with only another audio decoding module, the wireless or core network device may be used for transcoding, to enable the second electronic device to decode and play back a voice signal encoded by the first electronic device via the voice signal decoding module.

Specifically, the first electronic device encodes a voice signal via the voice signal decoding module, to obtain a first bitstream, performs channel encoding on the first bitstream, and then sends the first bitstream obtained through channel encoding to the wireless or core network device. Then, the channel decoding module of the wireless or core network device may perform channel decoding, and output, to the voice signal decoding module, the first bitstream obtained through channel decoding. Then, the voice signal decoding module decodes the first bitstream to obtain the voice signal, and outputs the voice signal to the another audio encoding module. Then, the another audio encoding module may encode the voice signal to obtain a second bitstream, and output the second bitstream to the channel encoding module. The channel encoding module performs channel encoding on the second bitstream, and then sends the second bitstream obtained through channel encoding to the second electronic device. In this way, the second electronic device may invoke the another audio decoding module to decode the second bitstream obtained through channel decoding, to obtain a reconstructed voice signal; and may play back the reconstructed voice signal subsequently.

In an end-to-end neural codec system, there is a vector quantization generative adversarial network (VQGAN)-based framework. A VQGAN-based voice coding system outputs a voice at a low bit rate during voice encoding, resulting in poor performance of a voice signal obtained by a decoding apparatus through decoding. For example, an objective of the VQGAN-based voice coding system is to minimize a sample point error between an original voice signal and a decoded voice signal. The decoded signal is not well restored when a bit rate is low (less than 6 kbps).

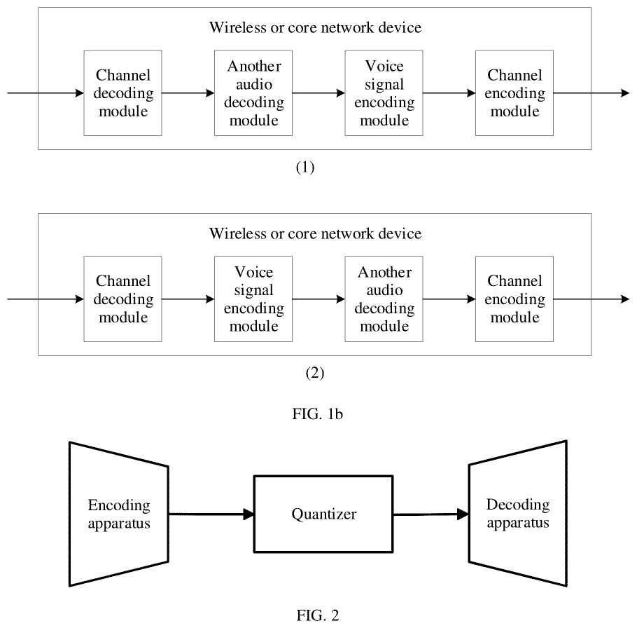

FIG. 2 is a diagram of a composition structure of a voice signal coding system according to an embodiment of this disclosure. The voice signal coding system may be specifically a style-based vector quantization generative adversarial network (StyleVQGAN) voice coding system. Compared with the foregoing VQGAN framework, in the voice signal coding system provided in this embodiment of this disclosure, an included decoder uses a style-based decoding apparatus, so that a decoded signal can be better reconstructed based on a quantized hidden-layer acoustic feature and an excitation feature, to reconstruct, in a generative adversarial manner, a decoded voice signal that is as close as possible to an original signal.

As shown in FIG. 2, the voice signal coding system provided in this embodiment of this disclosure includes an encoding apparatus, a quantizer, and a decoding apparatus.

The encoding apparatus is configured to: map an original voice signal into a hidden-layer acoustic feature, where the original voice signal may include a time domain signal; and input the acoustic feature into the quantizer.

The quantizer is configured to: compress the acoustic feature to obtain an encoded bitstream, where the encoded bitstream includes an acoustic feature compression result; and send the acoustic feature compression result in the encoded bitstream to the decoding apparatus via a transmission network.

The decoding apparatus is configured to obtain an acoustic feature encoding result in the encoded bitstream, where the acoustic feature encoding result is obtained by the encoding apparatus by performing feature extraction on the original voice signal.

The decoding apparatus is further configured to obtain a style feature from the acoustic feature encoding result, where the style feature indicates a voice style of the original voice signal.

The decoding apparatus is further configured to, in response to an obtained excitation feature, perform style fusion processing on the style feature and the excitation feature to obtain a fused voice feature.

The decoding apparatus is configured to generate a decoded voice signal based on the fused voice feature.

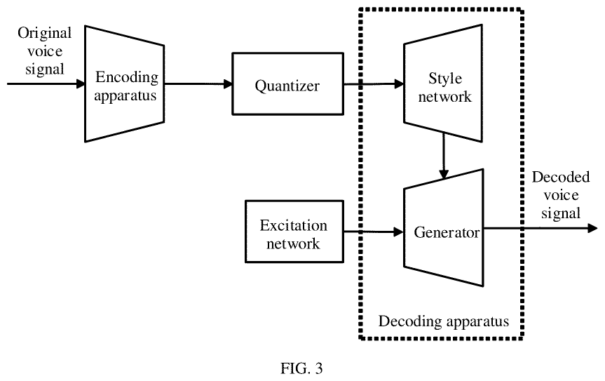

FIG. 3 is a diagram of a composition structure of another voice signal coding system according to an embodiment of this disclosure. The voice signal coding system further includes an excitation network and a style network. Specifically, the style network may belong to a decoding apparatus, or the style network is an independent functional component independent of a decoding apparatus. The decoding apparatus further includes a generator. The excitation network may belong to the decoding apparatus, or the excitation network is an independent functional component independent of the decoding apparatus.

The style network is configured to: obtain a style feature from an acoustic feature encoding result, and input the style feature into the generator.

The excitation network is configured to: obtain an excitation feature, and input the excitation feature into the generator.

For example, the excitation network may include a voice generation model, an excitation signal is generated via the voice generation model, and then, an excitation feature is extracted from the excitation signal. Specifically, the excitation network may include a sine wave-noise model, the excitation signal is generated via the sine wave-noise model, and then, the excitation feature is extracted from the excitation signal. For another example, the excitation network may include a white Gaussian noise generator and a constant sequence generator, an excitation signal is generated via the white Gaussian noise generator and the constant sequence generator, and then, an excitation feature is extracted from the excitation signal.

The generator is configured to synthesize the excitation feature into a decoded voice signal under guidance of the style feature as a condition.

For example, the excitation feature generated by the excitation network is used as an input excitation of the generator. The excitation feature includes a time-frequency domain feature map. The generator synthesizes the excitation feature into the decoded voice signal based on the time-frequency domain feature map as a condition.

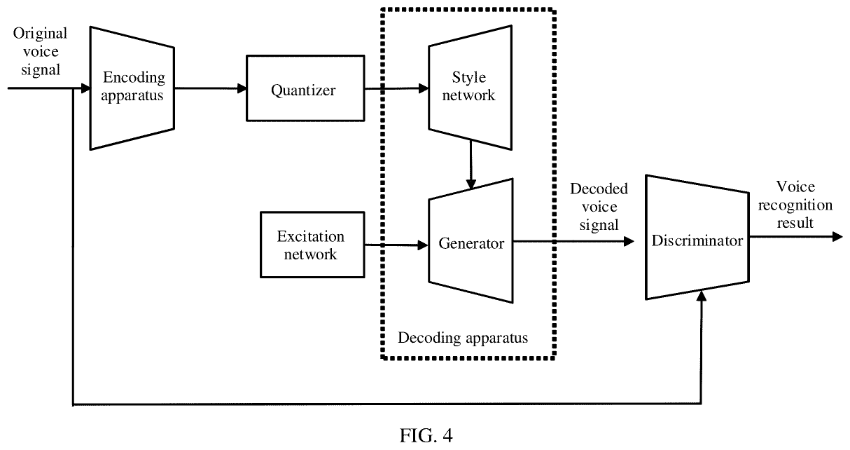

FIG. 4 is a diagram of a composition structure of another voice signal coding system according to an embodiment of this disclosure. The voice signal coding system further includes a discriminator. The discriminator is connected to a decoding apparatus, and after generating a decoded voice signal, a generator inputs the decoded voice signal into the discriminator.

The discriminator is configured to: receive the decoded voice signal and an original voice signal, and recognize the decoded voice signal and the original voice signal.

For example, the discriminator may be specifically a multi-scale time-frequency domain discriminator.

In this embodiment of this disclosure, the decoding apparatus and the discriminator reconstruct, in a generative adversarial manner, the decoded voice signal that is as close as possible to the original voice signal. The discriminator in the voice coding system is an optional apparatus. After model training of the voice coding system is completed, the discriminator may no longer be used to recognize the voice signal.

The following describes a voice signal coding process.

A voice encoding method on an encoder side provided in embodiments of this disclosure is first described.

An encoding apparatus mainly aims to map an input time domain signal into a hidden-layer acoustic representation. The encoding apparatus performs downsampling on the time domain signal, and finally outputs an acoustic representation including voice information. The acoustic representation is not sent a generator as a direct input. Instead, a style feature is obtained after the acoustic representation is processed via a style network, and the style feature is sent to the generator as an auxiliary input.

After obtaining an acoustic feature through mapping, the encoding apparatus inputs the acoustic feature into a quantizer. An objective of the quantizer is to compress the acoustic representation output by the encoding apparatus to a specific bit rate, to obtain an acoustic feature encoding result.

The following describes a voice decoding method on a decoder side provided in embodiments of this disclosure.

FIG. 5 is a diagram of an example of a decoding process. FIG. 5 shows the decoding process corresponding to the foregoing encoding process. The decoding process mainly includes the following steps.

501: Obtain an acoustic feature encoding result in an encoded bitstream.

An encoding apparatus may perform feature extraction on an original voice signal to obtain the acoustic feature encoding result. A bitstream is transmitted between the encoding apparatus and a decoding apparatus, and the decoding apparatus obtains the encoded bitstream from the encoding apparatus. The acoustic feature encoding result may alternatively be obtained through compression of a quantizer. This is not limited.

In some embodiments of this disclosure, a main part of an encoder is formed by stacking a plurality of encoder blocks. The decoding apparatus performs a decoding process reverse to that of the encoder. The decoding apparatus may include a plurality of decoder blocks. Example descriptions are as follows:

The encoding apparatus includes four encoder blocks; performs downsampling on the original voice signal, where downsampling rates are sequentially 2, 4, 5, and 8; and finally outputs a hidden-layer acoustic representation including voice information. The decoding apparatus may include four decoding modules including a style network module and a generator module, and upsampling rates of the decoding modules are sequentially 8, 5, 4, and 2.

502: Obtain a style feature from the acoustic feature encoding result, where the style feature indicates a voice style of the original voice signal.

After obtaining the acoustic feature encoding result from the encoded bitstream, the decoding apparatus performs voice style extraction based on the acoustic feature encoding result, to obtain the style feature. The style feature indicates the voice style of the original voice signal, and the style feature may be used as an input condition of a generator of the decoding apparatus, to guide the generator to reconstruct a voice signal.

503: In response to an obtained excitation feature, perform style fusion processing on the style feature and an excitation feature to obtain a fused voice feature.

The decoding apparatus may obtain the excitation feature. For example, the decoding apparatus obtains the excitation feature before obtaining the style feature, or obtains the excitation feature after obtaining the style feature, or the decoding apparatus obtains the style feature and the excitation feature at the same time.

In some embodiments of this disclosure, in addition to the foregoing steps, the voice signal decoding method provided in embodiments of this disclosure further includes the following steps.

A1: Obtain the excitation feature via an excitation network.

As shown in FIG. 3 or FIG. 4, the excitation network may generate the excitation feature. The decoding apparatus may receive the excitation feature input by the excitation network into the decoding apparatus. Alternatively, the decoding apparatus may include the excitation network, and the excitation network may generate the excitation feature. This resolves a problem in obtaining the excitation feature.

In some embodiments of this disclosure, as shown in FIG. 6, the excitation network includes an excitation signal generation model and a first convolution (ConV) module.

Step A1 of obtaining the excitation feature via the excitation network includes the following steps.

A11: Generate an excitation signal via the excitation signal generation model.

The excitation network includes the excitation signal generation model, and the excitation signal generation model may generate the excitation signal. For example, the excitation signal generation model may include a white Gaussian noise generator and a constant sequence generator, or may be a conventional voice generation model, for example, a pulse wave-noise model or a sine wave-noise model.

For example, the excitation signal generation model is a sine wave-noise model. An unvoiced or voiced state is determined based on the acoustic feature, to generate a corresponding excitation signal based on whether a frame signal is unvoiced or voiced. Gaussian noise excitation is used as an excitation signal in an unvoiced part, and sine wave excitation is used as an excitation signal in a voiced part.

A12: Perform convolution processing on the excitation signal via the first convolution module, to obtain the excitation feature.

The excitation signal is input into the first convolution module, and convolution is performed on the excitation signal, to output the excitation feature. A function of the first convolution module is to obtain the excitation feature that has a same dimension as the acoustic feature.

In this embodiment of this disclosure, the excitation signal generation model and the first convolution module are used, so that the excitation feature can be generated by using a simple device structure. This simplifies a process of generating the excitation feature.

In some embodiments of this disclosure, as shown in FIG. 6, the excitation network further includes a short-time Fourier transform (STFT) module.

Step A1 of obtaining the excitation feature via the excitation network further includes the following step:

A13: Extract a time-frequency domain feature from the excitation signal via the short-time Fourier transform module.

The time-frequency domain feature extracted from the excitation signal may be a time-frequency domain feature map. The time-frequency domain feature map generated via the excitation network is used as input excitation of the generator.

Step A12 of performing convolution processing on the excitation signal via the first convolution module includes the following step:

A121: Perform convolution processing on the time-frequency domain feature via the first convolution module.

The first convolution module performs convolution on the time-frequency domain feature, to output the excitation feature. The excitation feature and the acoustic feature have the same dimension, to simplify calculation.

In some embodiments of this disclosure, step 502 of obtaining the style feature from the acoustic feature encoding result includes the following steps.

B1: Obtain the style feature from the acoustic feature encoding result via a style network.

As shown in FIG. 3 or FIG. 4, the style network may obtain the style feature, and the decoding apparatus may input the style feature into the generator in the decoding apparatus, and reconstruct the voice signal via the generator. This resolves a problem in obtaining the style feature.

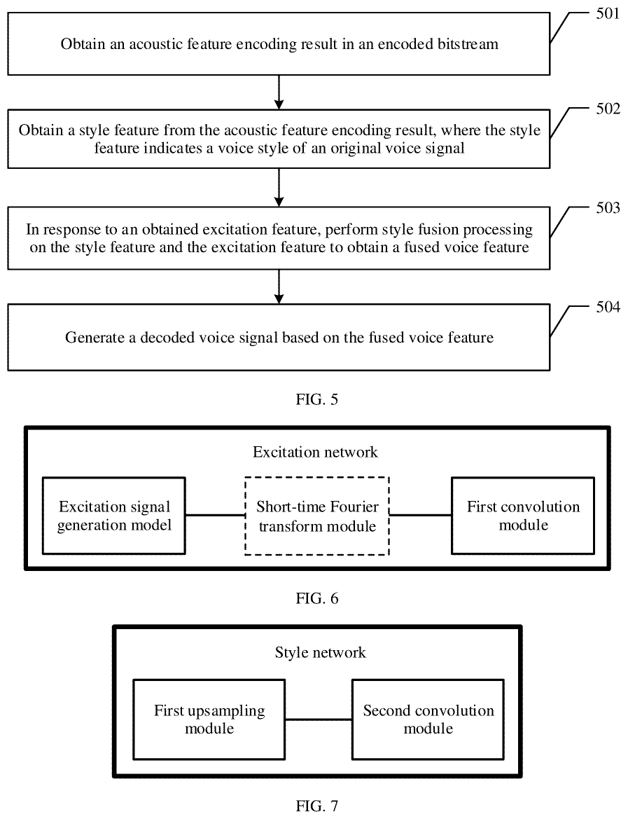

In some embodiments of this disclosure, as shown in FIG. 7, the style network includes a first upsampling module (Upsampler) and a second convolution module.

Step B1 of obtaining the style feature from the acoustic feature encoding result via the style network includes the following steps.

B11: Perform upsampling on the acoustic feature encoding result via the first upsampling module, to obtain an acoustic feature upsampling result.

The acoustic feature encoding result may include a quantized acoustic feature. The first upsampling module performs upsampling on the acoustic feature encoding result, to obtain the acoustic feature upsampling result. An upsampling operation performed by the first upsampling module corresponds to downsampling performed by the encoding apparatus.

B12: Perform convolution processing on the acoustic feature upsampling result via the second convolution module, to obtain the style feature.

The first upsampling module inputs the acoustic feature upsampling result into the second convolution module, and the second convolution module performs convolution processing on the acoustic feature upsampling result, to generate the style feature. The style feature indicates the voice style of the original voice signal. The style feature may also be referred to as a voice style feature.

In this embodiment of this disclosure, the first upsampling module and the second convolution module are used, so that the style feature can be generated by using a simple device structure. This simplifies a process of generating the style feature.

In some embodiments of this disclosure, the second convolution module may include two or more convolution layers. An input of a current layer is an output of a previous layer, and a convolution result is output by a last layer. An example in which the second convolution module includes two convolution layers is used for description. As shown in FIG. 8, the second convolution module includes a first convolution layer and a second convolution layer.

In some embodiments of this disclosure, the style network includes a first upsampling module, a first convolution layer, and a second convolution layer. For example, the style network includes the first upsampling module (Upsampler) and a second convolution module. As shown in FIG. 8, the second convolution module includes the first convolution layer and the second convolution layer.

Step B1 of obtaining the style feature from the acoustic feature encoding result via the style network includes the following steps.

B13: Perform upsampling on the acoustic feature encoding result via the first upsampling module, to obtain an acoustic feature upsampling result.

An implementation of step B13 is similar to that of step B11. Details are not described herein again.

B14: Input the acoustic feature upsampling result into the first convolution layer for convolution processing, to obtain a style sub-feature.

The first convolution layer is a top layer in the second convolution module. The acoustic feature upsampling result is input into the first convolution layer. The first convolution layer performs convolution processing on the acoustic feature upsampling result, to output the style sub-feature. The style sub-feature indicates the voice style that is extracted by the first convolution layer and that is of the original voice signal.

B15: Input the style sub-feature into the first upsampling module for upsampling, to obtain a style upsampling result.

The first convolution layer inputs the style sub-feature into the first upsampling module, and the first upsampling module continues to perform upsampling on the style sub-feature, to obtain the style upsampling result. The style upsampling result represents a result obtained by performing upsampling on the style sub-feature. In addition, the first convolution layer inputs the style sub-feature into the generator.

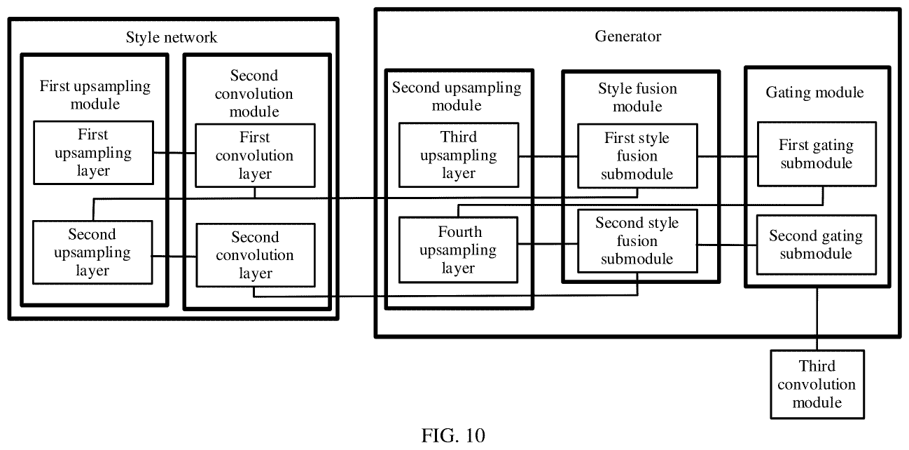

It may be understood that the first upsampling module performs upsampling in both step B11 and step B15, and upsampling may be specifically performed by different layers included in the first upsampling module. For example, as shown in FIG. 10, the first upsampling module includes a first upsampling layer and a second upsampling layer. The first upsampling layer performs step B11, and the second upsampling layer performs step B15.

B16: Input the style upsampling result into the second convolution layer for convolution processing, to obtain the style feature.

The first upsampling module inputs the style upsampling result into the second convolution layer, and continues to perform convolution processing on the style upsampling result via the second convolution layer, to obtain the style feature. In this example, the second convolution module includes two convolution layers, and the second convolution layer is a last layer. In this case, the second convolution layer inputs the style sub-feature into the generator. It may be understood that if the second convolution module includes more layers, the second convolution layer still needs to send the style feature to a next layer.

In this embodiment of this disclosure, the first convolution layer and the second convolution layer are used, so that the style feature can be generated by using a simple device structure. This simplifies a process of generating the style feature, and resolves a problem in generating the style feature during multi-layer stacking of the convolution module.

In some embodiments of this disclosure, as shown in FIG. 3 or FIG. 4, step 503 of performing style fusion processing on the style feature and the excitation feature, to obtain the fused voice feature includes the following steps.

C1: Separately input the style feature and the excitation feature into the generator, and perform style fusion processing on the style feature and the excitation feature via the generator, to obtain the fused voice feature.

The decoding apparatus includes the style network and the generator. The decoding apparatus may also be referred to as a style-based decoder. The generator in the decoding apparatus separately receives the style feature and the excitation feature, and then, the generator performs style fusion processing on the style feature and the excitation feature, to obtain the fused voice feature. The fused voice feature carries the voice style of the original voice signal, and therefore signal quality of the reconstructed voice signal can be improved.

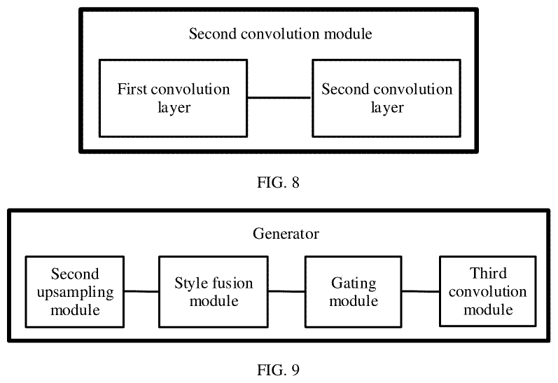

In some embodiments of this disclosure, as shown in FIG. 9, the generator includes a second upsampling module, a style fusion module (StyleBlock), a gating module (Gated Function), and a third convolution module.

Step C1 of performing style fusion processing on the style feature and the excitation feature via the generator, to obtain the fused voice feature includes the following steps:

C11: Perform upsampling processing on the excitation feature via the second upsampling module, to obtain a first signal feature.

The excitation network inputs the excitation feature into the second upsampling module. The second upsampling module performs upsampling processing on the excitation feature, to obtain the first signal feature. An upsampling operation performed by the second upsampling module corresponds to downsampling performed by the encoding apparatus.

It can be understood that the second upsampling module and the first upsampling module have a same quantity of sampling layers. For example, as shown in FIG. 10, the second upsampling module includes a third upsampling layer and a fourth upsampling layer, and the third upsampling layer performs step C11.

C12: Perform linear modulation on the first signal feature and the style feature via the style fusion module, to obtain a second signal feature, and process the second signal feature via the gating module, to obtain a third signal feature.

The style network inputs the style feature into the style fusion module, the second upsampling module inputs the first signal feature into the style fusion module, and the style fusion module performs linear modulation on the first signal feature and the style feature, to obtain the second signal feature. Example descriptions are as follows: The style fusion module performs style fusion according to a temporal adaptive de-normalization (TADE) algorithm, and the style fusion module performs linear modulation on the first signal feature and the style feature according to the TADE algorithm, to obtain the second signal feature.

After generating the second signal feature, the style fusion module inputs the second signal feature into the gating module. The gating module processes the second signal feature, to obtain the third signal feature. The gating module can reduce quantization noise in the second signal feature, thereby improving quality of the decoded voice signal.

C13: Perform convolution processing on the third signal feature via the third convolution module, to obtain the fused voice feature.

After generating the third signal feature, the gating module inputs the third signal feature into the third convolution module. The third convolution module performs convolution processing on the third signal feature, to obtain the fused voice feature. The third convolution module performs convolution processing, so that the fused voice feature can have the same dimension as the acoustic feature of the original voice signal, thereby improving quality of the decoded voice signal.

In this embodiment of this disclosure, the second upsampling module, the style fusion module, the gating module, and the third convolution module are used, so that style fusion can be implemented by using a simple device structure. This simplifies a style fusion processing process, and resolves a problem existing when the generator synthesizes the excitation feature into the high-quality decoded voice signal.

In some embodiments of this disclosure, the second upsampling module may include two or more upsampling layers. An input of a current layer is an output of a previous layer, and an upsampling result is output by a last layer. An example in which the second upsampling module includes two upsampling layers is used for description. As shown in FIG. 10, the second upsampling module includes the third upsampling layer and the fourth upsampling layer.

Similarly, the style fusion module included in the generator includes two or more style fusion submodules. In some embodiments of this disclosure, as shown in FIG. 10, an example in which the style fusion module includes a first style fusion submodule and a second style fusion submodule is used for description.

The gating module included in the generator includes two or more gating submodules. In some embodiments of this disclosure, as shown in FIG. 10, an example in which the gating module includes a first gating submodule and a second gating submodule is used for description.

Based on the style network and the generator shown in FIG. 10, step C12 of performing linear modulation on the first signal feature and the style feature via the style fusion module, to obtain the second signal feature, and processing the second signal feature via the gating module, to obtain the third signal feature includes the following steps.

C121: Perform linear modulation on the first signal feature and the style feature via the first style fusion submodule, to obtain a first modulation result.

The excitation network inputs the excitation feature into the third upsampling layer in the second upsampling module. The third upsampling layer performs upsampling processing on the excitation feature, to obtain the first signal feature. The third upsampling layer inputs the first signal feature into the first style fusion submodule. When performing style fusion, the first style fusion submodule may perform fusion on the first signal feature and the style feature in a linear modulation manner, to obtain the first modulation result. The first style fusion submodule inputs the first modulation result into the first gating submodule.

As shown in FIG. 10, the style feature input into the first style fusion submodule is specifically the style sub-feature output by the first convolution layer in the second convolution module.

C122: Process the first modulation result via the first gating submodule, to obtain a first gating result.

The first gating submodule processes the first modulation result, to obtain the first gating result. The first gating submodule can reduce quantization noise in the first modulation result, thereby improving quality of the decoded voice signal.

After obtaining the first gating result, the first gating submodule inputs the first gating result into the fourth upsampling layer in the second upsampling module. The fourth upsampling layer performs upsampling processing on the first gating result, to obtain an upsampled first gating result. The fourth upsampling layer inputs the upsampled first gating result to the second style fusion submodule.

C123: Perform linear modulation on the first gating result and the style feature via the second style fusion submodule, to obtain a second modulation result.

When performing style fusion, the second style fusion submodule may perform fusion on the first gating result and the style feature in a linear modulation manner, to obtain the second modulation result. The second style fusion submodule inputs the second modulation result into the second gating submodule.

As shown in FIG. 10, the style feature input into the second style fusion submodule is specifically the style feature output by the second convolution layer in the second convolution module.

C124: Process the second modulation result via the second gating submodule, to obtain the third signal feature.

The second gating submodule processes the second modulation result, to obtain the third signal feature. The second gating submodule can reduce quantization noise in the second modulation result, thereby improving quality of the decoded voice signal.

In this embodiment of this disclosure, the first style fusion submodule, the second style fusion submodule, the first gating submodule, and the second gating submodule are used, so that the third signal feature can be generated by using a simple device structure. This simplifies a process of generating the signal feature, and resolves a problem in generating the third signal feature during multi-layer stacking of the style fusion module and the gating module.

504: Generate the decoded voice signal based on the fused voice feature.

After the decoding apparatus generates the fused voice feature in step 503, the decoding apparatus may reconstruct the voice signal based on the fused voice feature, to generate the decoded voice signal. In this embodiment of this disclosure, because a style-based decoding apparatus is used at the decoder side, the decoded voice signal can be better reconstructed based on both the acoustic feature and the excitation feature. This improves the quality of the decoded voice signal.

In some embodiments of this disclosure, in addition to the foregoing steps, the voice signal decoding method provided in embodiments of this disclosure further includes the following step.

D1: Input the decoded voice signal and the original voice signal into a discriminator, and recognize the decoded voice signal and the original voice signal via the discriminator.

As shown in FIG. 4, the discriminator is connected to the decoding apparatus. After generating the decoded voice signal, the generator inputs the decoded voice signal into the discriminator. The decoding apparatus and the discriminator reconstruct, in a generative adversarial manner, the decoded voice signal that is as close as possible to the original voice signal. When a voice coding system performs model training via a generative adversarial network, the discriminator is used to distinguish between the original voice signal and the decoded voice signal in the training process, to improve training accuracy. After the voice coding system completes training, the voice coding system may not include the discriminator.

It can be learned from the example descriptions in the foregoing embodiment that the encoding apparatus encodes the original voice signal, to obtain the encoded bitstream. The encoded bitstream includes the acoustic feature encoding result. The decoding apparatus obtains the acoustic feature encoding result in the encoded bitstream, and obtains the style feature from the acoustic feature encoding result. The decoding apparatus obtains the excitation feature, performs style fusion processing on the excitation feature and the style feature, to obtain the fused voice feature, and reconstructs the decoded voice signal based on the voice feature. Because the style feature indicates the voice style of the original voice signal, a voice feature in the original voice signal can be restored from the voice feature obtained by performing style fusion on the excitation feature and the style feature. In this way, quality of the decoded voice signal reconstructed based on the fused voice feature can be effectively improved in comparison with that of a decoded voice signal obtained without style fusion.

For better understanding and implementation of the foregoing solutions in embodiments of this disclosure, specific descriptions are provided below by using corresponding application scenarios as examples.

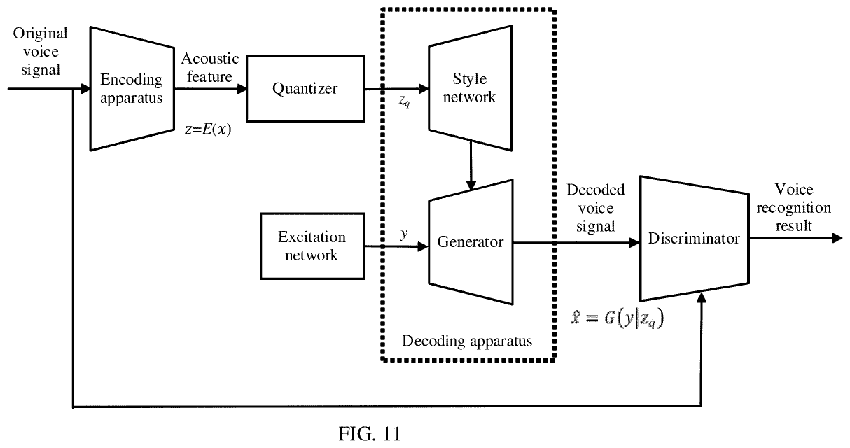

In scenarios such as an online conference, online education, and satellite communication, quality of voice communication is a focus of attention of users. Embodiments of this disclosure are oriented to such scenarios. FIG. 11 shows a voice coding system according to an embodiment of this disclosure. The voice coding system mainly includes an encoding apparatus, a quantizer, an excitation network, a style-based decoding apparatus, and a discriminator. The discriminator is configured to distinguish between an original voice signal and a decoded voice signal only in a model training process, to improve training accuracy. When a voice signal is actually decoded in the voice coding system, the discriminator does not need to be disposed in the voice coding system.

The voice coding system uses a style-based VQGAN (that is, StyleVQGAN) coding framework. The voice coding system mainly includes:
the encoding apparatus, configured to perform a downsampling operation on an original voice signal, to finally extract a hidden-layer acoustic representation;
the excitation network, configured to: generate an excitation signal via a voice generation model, and convert the excitation signal into an excitation feature via a network, where the excitation feature is used as an input parameter of the style-based decoding apparatus; and
the quantizer, configured to compress the hidden-layer acoustic representation obtained by the encoding apparatus, to obtain a quantized acoustic representation.

The style-based decoding apparatus includes a style network and a generator.

The style network is configured to: perform upsampling on the quantized acoustic representation, to obtain a style feature, and use the style feature as an input condition of the generator.

The generator is configured to synthesize the excitation feature into a decoded voice signal under guidance of the style feature.

The voice coding system provided in this embodiment of this disclosure includes the excitation network and the style-based decoding apparatus (Style-based decoder). Compared with that the decoding apparatus reconstructs a voice signal based on only the quantized hidden-layer acoustic representation, in this embodiment of this disclosure, the excitation feature including voice prior knowledge is generated as an input parameter of the generator via the excitation network, then, a style feature in the original voice signal is extracted from the hidden-layer acoustic representation via the style network, and finally the excitation feature is synthesized into the decoded voice signal via the generator under the guidance of the style feature as a condition. A high-quality voice signal is reconstructed at lowest possible bit rate consumption, thereby improving voice coding efficiency and user communication experience.

As shown in FIG. 11, the following separately describes the encoding apparatus, the quantizer, the excitation network, the style-based decoding apparatus, and the discriminator by using examples.

### 1. Encoding Apparatus

The encoding apparatus mainly aims to map an input time domain signal into a hidden-layer acoustic representation.

A main part of the encoding apparatus is formed by stacking a plurality of encoder blocks Each encoder block includes a downsampling convolution layer and a residual unit including two one-dimensional convolution layers. A voice signal is continuously downsampled via these encoder blocks. For example, downsampling rates are sequentially 2, 4, 5, and 8. An acoustic representation including voice information is finally output.

$$z = E ( x ) .$$

In the encoding apparatus different from the VQGAN coding framework, the acoustic representation is not sent to a generator as a direct input. Instead, a style feature is obtained after the acoustic representation is processed via a style network, and is sent to the generator as an auxiliary input, and then, an excitation feature is converted into a decoded voice signal via a decoding apparatus.

### 2. Quantizer

The quantizer is to compress, to a specific bit rate, an acoustic representation z output by an encoding apparatus. In this embodiment of this disclosure, a residual vector quantizer (RVQ) is used to learn a codebook, to further quantize the acoustic representation output by the encoding apparatus. Z represents the codebook in the following formula. A quantization algorithm is to find, for each element zᵢⱼ in Z, a code vector zₖ closest to the element in the codebook for replacement. An initial value of the codebook is obtained through clustering, and then, values of the codebook are adjusted through neural network training.

$${z}_{q} = q ( z ) = arg {min}_{{z}_{k} ∈ Z} ‖ {z}_{ij} - {z}_{k} ‖ .$$

### 3. Excitation Network

As shown in FIG. 6, the excitation network mainly aims to generate an excitation feature as an input parameter of a generator. The excitation network used in embodiments mainly includes an excitation signal generation model, a short-time Fourier transform (STFT) module, and a first convolution module. The first convolution module is to obtain an excitation feature that has a same dimension as a hidden-layer acoustic feature. The excitation signal generation model may be a voice generation model, for example, a sine wave-noise model. An unvoiced or voiced state is determined based on the hidden-layer acoustic feature z_{q}, to generate a corresponding signal. Gaussian noise excitation is used as an excitation feature in an unvoiced part, and sine wave excitation is used as an excitation feature in a voiced part.

It may be understood that the dimension of the hidden-layer acoustic feature is determined by the encoding apparatus. For ease of a subsequent style fusion operation, a dimension of a feature finally output by the excitation network needs to be the same as the dimension of the hidden-layer acoustic feature.

### 4. Style-Based Decoding Apparatus

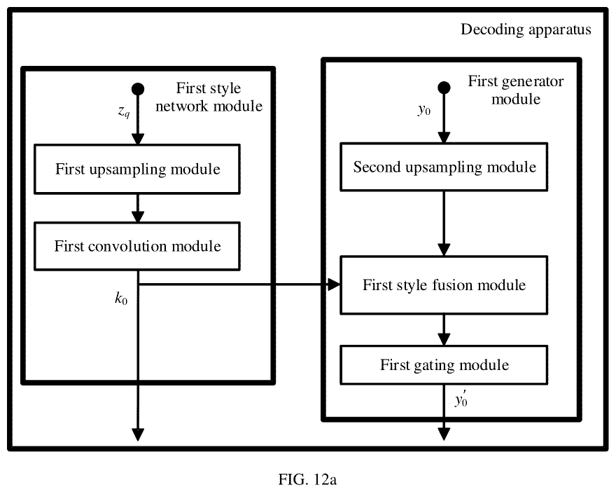

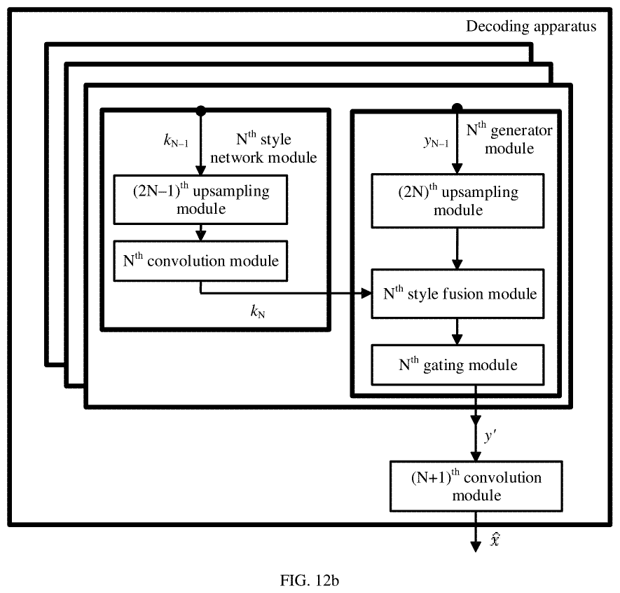

Each of FIG. 12a and FIG. 12b shows a style-based decoding apparatus according to an embodiment of this disclosure. The decoding apparatus has a plurality of layers. For example, the decoding apparatus has N layers, and a value of N is not limited. Each layer of the decoding apparatus includes one style network module and one generator module.

For example, as shown in FIG. 12a, a first layer of the decoding apparatus includes a first style network module and a first generator module. The first style network module includes a first upsampling module and a first convolution module. An input of the first upsampling module is a hidden-layer acoustic feature z_{q}, and an output of the first convolution module is k₀. The first convolution module inputs k₀ into a second style fusion module and a second upsampling module in the first generator module. The first generator module includes a second upsampling module, a first style fusion module, and a first gating module. An input of the second upsampling module is an excitation feature y₀, and an output of the first gating module is y′₀. The first gating module inputs y′₀ into a fourth upsampling module in a second generator module.

As shown in FIG. 12b, an N^{th} layer of the decoding apparatus includes an N^{th} style network module and an N^{th} generator module. The N^{th} style network module includes a (2N−1)^{th} upsampling module and an N^{th} convolution module. An input of the (2N−1)^{th} upsampling module is a hidden-layer acoustic feature k_{N-1}, and an output of the N^{th} convolution module is k_{N}. The N^{th} convolution module inputs k_{N} into a (2N)^{th} upsampling module in the N^{th} generator module. The N^{th} generator module includes the (2N)^{th} upsampling module, the N^{th} style fusion module, and the N^{th} gating module. An input of the (2N)^{th} upsampling module is y_{N-1} output by an (N−1)^{th} gating module, and an output of the N^{th} gating module is y′. The N^{th} gating module inputs y′ into an (N+1)^{th} convolution module. The (N+1)^{th} convolution module performs convolution processing on y′, to output a decoded voice signal \hat{x}.

The style-based decoding apparatus includes two parts: a style network and a generator. A main function is to establish mapping between an input excitation feature y and a target voice x under guidance of a hidden-layer acoustic feature output by an encoding apparatus as condition information. The decoded voice signal \hat{x} output by the decoding apparatus satisfies the following relationship:

$$\hat{x} = G ( y \vert {z}_{q} ) = G ( y \vert q ( E ( x ) ) ) .$$

Herein, G represents a generator, E represents an encoder, and q represents a quantizer.

The decoding apparatus includes N style network modules and N generator modules. One style network module and one generator module form one decoding submodule. For example, N is equal to 4, and upsampling rates of four layers in the decoding apparatus are sequentially 8, 5, 4, and 2.

An initial input of the style network module is the hidden-layer acoustic feature z_{q}, a style feature is generated through upsampling and convolution, and the style feature is input into the generator module.

An initial input of the generator module is the excitation feature y, and after corresponding upsampling, style fusion is performed on two features in the style fusion module (StyleBlock). A fusion algorithm used by the style fusion module is temporal adaptive de-normalization (TADE), and the input excitation feature and the style feature are fused in a linear modulation manner. Specific implementations are as follows.

First, the input excitation feature is normalized, then the style feature is mapped into two modulation parameters γ and β via a convolutional network, and finally a normalized excitation feature is linearly modulated according to the following formula γ*y+β, where * represents a multiplication operation.

Then, an input of each decoding submodule is a fused excitation feature and an upsampled hidden-layer acoustic feature.

An output fused signal y′ of a last decoding submodule is processed by a convolution layer, to obtain the decoded voice signal \hat{x}.

### 5. Discriminator

In embodiments of this disclosure, a multi-scale STFT discriminator is used, and an input is real parts and imaginary parts of time-frequency domain signals of an original voice signal and a decoded voice signal. A plurality of STFT sub-discriminators of different scales are obtained based on different window lengths and different quantities of points of Fourier transform.

In this embodiment, the voice coding system is trained in an end-to-end manner. The voice coding system is implemented via a vector quantization (VQ)-generative adversarial network (GAN), where VQ is a vector quantization algorithm used by a quantizer, and GAN is a network architecture including a coding apparatus and a discriminator. Network parameters of the encoding apparatus and the decoding apparatus in the system, and codebook parameters are optimized by minimizing an objective function. The objective function includes an adversarial loss of a generative adversarial network, a difference between feature maps output by the discriminator, and a quantization loss of the RVQ. In a specific application scenario, only the encoding apparatus, the quantizer, and the generator are used to implement an end-to-end voice coding process.

Next, quality of a decoded voice signal of the voice coding system provided in this embodiment of this disclosure is tested. In this embodiment, testing is performed in an open-source voice database (for example, a LibriTTS dataset). The dataset is a multi-speaker English corpus, there are 585 hours of English data in total, and a sampling rate is 24 kHz. 100 hours of voice data are used for training, and 300 voices are used as test data. A bit rate for testing is 6 kbps, and a VQ-GAN voice coding system that does not use a style feature and an excitation feature is compared. Evaluation algorithms are perceptual evaluation of speech quality (PESQ) and short-time objective intelligibility (STOI). The PESQ mainly evaluates objective perceptual quality of a voice, and the STOI mainly focuses on voice intelligibility.

As shown in Table 1, objective scores of the style-based VQ-GAN system provided in embodiments of this disclosure in two evaluation indicators are higher than those of the VQ-GAN system used as a baseline. Therefore, in embodiments of this disclosure, the decoded voice signal is reconstructed based on both the hidden-layer acoustic representation information of the original voice signal and the excitation feature obtained based on the prior knowledge of the excitation signal, to obtain better benefits.

TABLE 1
Comparison of objective quality scores
of coded voices in different systems

| Coding system | | | |
|---|---|---|---|
| (6 kbps) | Excitation signal | PESQ | STOI |
| VQ-GAN without | None | 3.6818 | 0.9588 |
| style fusion | | | |
| Style VQ-GAN | Time-frequency domain signal | 3.7373 | 0.9669 |
| | generated by a sine wave-noise | | |
| | model | | |

In this embodiment, the excitation network is added to the end-to-end neural coding framework, and the style-based decoding apparatus is used. The excitation feature output by the excitation network provides prior knowledge of a voice model for the generator, and the style-based decoding apparatus better restores the decoded voice signal with higher quality based on the hidden-layer acoustic feature of the voice signal.

In the foregoing embodiment of this disclosure, the excitation signal generation model is the voice generation model, and a time-frequency domain feature is obtained via the STFT module. The excitation signal may be selected in more manners. For example, a white Gaussian noise generator or a constant sequence generator may be used, or a time domain signal of a voice generation model (for example, a sine wave-noise model) may be used.

As shown in Table 2, inputs generated by different excitation signals affect a final result. When the input is a time-frequency domain feature of the sine wave-noise model, system performance is optimal because the input signal includes most useful information. However, compared with the VQ-GAN system without style fusion used as the baseline in Table 1, the style-based VQ-GAN system provided in this embodiment of this disclosure has better effect under the different excitation signals.

TABLE 2
Comparison of objective quality scores of coded
voices under different excitation signals

| Coding system | | | |
|---|---|---|---|
| (6 kbps) | Excitation signal | PESQ | STOI |
| Style VQ-GAN | White Gaussian noise | 3.6976 | 0.9614 |
| | Constant sequence | 3.7219 | 0.9618 |
| | Time domain signal generated | 3.7243 | 0.9646 |
| | by a sine wave-noise model | | |
| | Time-frequency domain feature | 3.7373 | 0.9669 |
| | generated by the sine wave-noise | | |
| | model | | |

It can be learned from the foregoing example description that the excitation network generates the excitation signal via the voice generation model, and extracts the excitation feature of the excitation signal via the convolutional network as the input of the decoding apparatus. The style-based decoding apparatus performs upsampling on the quantized hidden-layer acoustic representation via the style network, to obtain the style feature, and guides, based on the style feature as the condition information, the generator to synthesize the excitation feature into the decoded voice signal.

The voice coding system provided in this embodiment of this disclosure may use the style-based VQ-GAN framework. The excitation network is newly added to the audio and video field. The decoded voice signal is better reconstructed based on the excitation feature generated by the excitation network and the prior knowledge of the voice model. The style-based decoding apparatus guides, based on the style feature as a condition, the generator to synthesize the excitation feature into the decoded voice signal. In this embodiment of this disclosure, the decoded voice with higher quality can be obtained based on the two parts of information: the excitation signal and the quantized hidden-layer representation.

It should be noted that, for brief description, the foregoing method embodiments are represented as a series of actions. However, a person skilled in the art should appreciate that this disclosure is not limited to the described order of the actions because some steps may be performed in another order or simultaneously according to this disclosure. It should be further appreciated by a person skilled in the art that embodiments described in this specification all belong to optional embodiments, and the involved actions and modules are not necessarily required by this disclosure.

To better implement the solutions of embodiments of this disclosure, a related apparatus for implementing the solutions is further provided below.

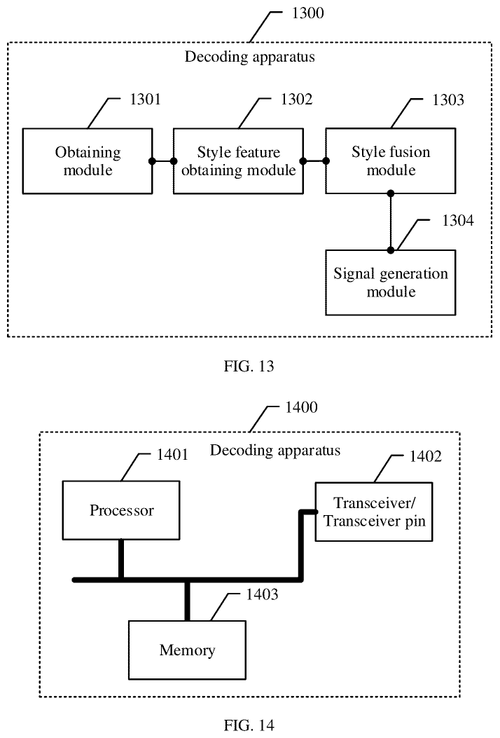

FIG. 13 is a diagram of an example of a structure of a voice signal decoding apparatus. The voice signal decoding apparatus shown in FIG. 13 may be configured to perform the voice signal decoding method in the foregoing embodiment. Therefore, for beneficial effect that can be achieved by the voice signal decoding apparatus, refer to the beneficial effect of the corresponding method provided above. Details are not described herein again. The voice signal decoding apparatus may include:
an obtaining module 1301, configured to obtain an acoustic feature encoding result in an encoded bitstream;
a style feature obtaining module 1302, configured to obtain a style feature from the acoustic feature encoding result, where the style feature indicates a voice style of an original voice signal;
a style fusion module 1303, configured to, in response to an obtained excitation feature, perform style fusion processing on the style feature and an excitation feature to obtain a fused voice feature; and
a signal generation module 1304, configured to generate a decoded voice signal based on the fused voice feature.

In an example, FIG. 14 is a block diagram of an apparatus 1400 according to an embodiment of this disclosure. The apparatus 1400 may include a processor 1401 and a transceiver/transceiver pin 1402, and optionally, further include a memory 1403.

Components of the apparatus 1400 are coupled together through a bus 1404. In addition to a data bus, the bus 1404 further includes a power bus, a control bus, and a status signal bus. However, for clarity of description, various buses in the figure are referred to as the bus 1404.

Optionally, the memory 1403 may be configured to store instructions in the foregoing method embodiments. The processor 1401 may be configured to: execute the instructions in the memory 1403, control a receive pin to receive a signal, and control a transmit pin to send a signal. Specifically, the processor 1401 performs the foregoing voice signal decoding method.

The apparatus 1400 may be the electronic device or a chip of the electronic device in the foregoing method embodiments.

A11 related content of the steps in the foregoing method embodiments may be cited in function descriptions of the corresponding functional modules. Details are not described herein again.

An embodiment further provides a chip. The chip includes one or more interface circuits and one or more processors. The interface circuit is configured to: receive a signal from a memory of an electronic device, and send the signal to the processor. The signal includes computer instructions stored in the memory. When the processor executes the computer instructions, the electronic device is enabled to perform the method in the foregoing embodiments. The interface circuit may be the transceiver 1402 in FIG. 14.

An embodiment further provides a computer-readable storage medium. The computer-readable storage medium stores computer instructions. When the computer instructions are run on an electronic device, the electronic device is enabled to perform the foregoing related method steps, to implement the voice signal decoding method in the foregoing embodiments.

An embodiment further provides a computer program product. When the computer program product runs on a computer, the computer is enabled to perform the foregoing related steps, to implement the voice signal decoding method in the foregoing embodiments.

In addition, an embodiment of this disclosure further provides an apparatus. The apparatus may be specifically a chip, a component, or a module. The apparatus may include a processor and a memory that are connected to each other. The memory is configured to store computer-executable instructions. When the apparatus runs, the processor may execute the computer-executable instructions stored in the memory, to enable the chip to perform the voice signal decoding method in the foregoing method embodiments.

The electronic device, the computer-readable storage medium, the computer program product, or the chip provided in embodiments is configured to perform the corresponding method provided above. Therefore, for beneficial effect that can be achieved, refer to the beneficial effect of the corresponding method provided above. Details are not described herein again.

Based on the descriptions of the implementations, a person skilled in the art may understand that for the purpose of convenient and brief description, division into the functional modules is merely used as an example for description. In actual application, the functions may be allocated to different functional modules for completion based on a requirement. In other words, an inner structure of an apparatus is divided into different functional modules, to implement all or some of the functions described above.

In the several embodiments provided in this disclosure, it should be understood that the disclosed apparatus and method may be implemented in another manner. For example, the described apparatus embodiment is merely an example. For example, division into the modules or units is merely logical function division. There may be another division manner in actual implementation. For example, a plurality of units or components may be combined or may be integrated into another apparatus, or some features may be ignored or not be performed. In addition, the displayed or discussed mutual couplings or direct couplings or communication connections may be implemented through some interfaces. The indirect couplings or communication connections between the apparatuses or units may be implemented in an electrical form, a mechanical form, or another form.

The units described as separate parts may or may not be physically separate, and parts displayed as units may be one or more physical units, may be located in one place, or may be distributed in a plurality of different places. Some or all of the units may be selected based on actual requirements to achieve the objectives of the solutions in embodiments.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

Any content of embodiments of this disclosure and any content of a same embodiment may be freely combined. Any combination of the foregoing content shall fall within the scope of this disclosure.

When the integrated unit is implemented in the form of the software functional unit and sold or used as an independent product, the integrated unit may be stored in a readable storage medium. Based on such an understanding, the technical solutions of embodiments of this disclosure essentially, or the part contributing to the conventional technology, or all or some of the technical solutions may be implemented in a form of a software product. The software product is stored in a storage medium and includes several instructions for instructing a device (which may be a single-chip microcomputer, a chip, or the like) or a processor to perform all or some of the steps of the method described in embodiments of this disclosure. The foregoing storage medium includes any medium that can store program code, for example, a USB flash drive, a removable hard disk, a read-only memory (ROM), a random access memory (RAM), a magnetic disk, or an optical disc.

Embodiments of this disclosure are described above with reference to the accompanying drawings. However, this disclosure is not limited to the foregoing specific implementations. The foregoing specific implementations are merely examples, but are not limitative. Inspired by this disclosure, a person of ordinary skill in the art may further make many modifications without departing from the purposes of this disclosure and the protection scope of the claims, and all the modifications shall fall within protection of this disclosure.

Methods or algorithm steps described in combination with the content disclosed in embodiments of this disclosure may be implemented by hardware, or may be implemented by a processor by executing a software instruction. The software instruction may include a corresponding software module. The software module may be stored in a random access memory (RAM), a flash memory, a read-only memory (OM), an erasable programmable read-only memory EPROM), an electrically erasable programmable read-only memory (Electrically EPROM, EEPROM), a register, a hard disk, a removable hard disk, a compact disc read-only memory (CD-ROM), or any other form of storage medium well-known in the art. For example, a storage medium is coupled to the processor, so that the processor can read information from the storage medium and write information into the storage medium. Certainly, the storage medium may be a component of the processor. The processor and the storage medium may be located in the ASIC.

A person skilled in the art should be aware that in the foregoing one or more examples, functions described in embodiments of this disclosure may be implemented by hardware, software, firmware, or any combination thereof. When the functions are implemented by software, the foregoing functions may be stored in a computer-readable medium or transmitted as one or more instructions or code in a computer-readable medium. The computer-readable medium includes a computer-readable storage medium and a communication medium, where the communication medium includes any medium that enables a computer program to be transmitted from one place to another place. The storage medium may be any available medium accessible to a general-purpose or dedicated computer.

Embodiments of this disclosure are described above with reference to the accompanying drawings. However, this disclosure is not limited to the foregoing specific implementations. The foregoing specific implementations are merely examples, but are not limitative. Inspired by this disclosure, a person of ordinary skill in the art may further make many modifications without departing from the purposes of this disclosure and the protection scope of the claims, and all the modifications shall fall within protection of this disclosure.

1. A voice signal decoding method, wherein the method comprises:
obtaining an acoustic feature encoding result in an encoded bitstream;
obtaining a style feature from the acoustic feature encoding result, wherein the style feature indicates a voice style of an original voice signal;
in response to an obtained excitation feature, performing style fusion processing on the style feature and the excitation feature to obtain a fused voice feature; and
generating a decoded voice signal based on the fused voice feature.

2. The method according to claim 1, wherein the method further comprises:
obtaining the excitation feature via an excitation network.

3. The method according to claim 2, wherein the excitation network comprises an excitation signal generation model and a first convolution module; and
obtaining the excitation feature via the excitation network comprises:
generating an excitation signal via the excitation signal generation model; and
performing convolution processing on the excitation signal via the first convolution module, to obtain the excitation feature.

4. The method according to claim 3, wherein the excitation network further comprises a short-time Fourier transform module;
obtaining the excitation feature via the excitation network further comprises: extracting a time-frequency domain feature from the excitation signal via the short-time Fourier transform module; and
performing convolution processing on the excitation signal via the first convolution module comprises: performing convolution processing on the time-frequency domain feature via the first convolution module.

5. The method according to claim 1, wherein obtaining the style feature from the acoustic feature encoding result comprises:
obtaining the style feature from the acoustic feature encoding result via a style network.

6. The method according to claim 5, wherein the style network comprises a first upsampling module and a second convolution module; and
obtaining the style feature from the acoustic feature encoding result via the style network comprises:
performing upsampling on the acoustic feature encoding result via the first upsampling module, to obtain an acoustic feature upsampling result; and
performing convolution processing on the acoustic feature upsampling result via the second convolution module, to obtain the style feature.

7. The method according to claim 5, wherein the style network comprises a first upsampling module, a first convolution layer, and a second convolution layer; and
obtaining the style feature from the acoustic feature encoding result via the style network comprises:
performing upsampling on the acoustic feature encoding result via the first upsampling module, to obtain an acoustic feature upsampling result;
inputting the acoustic feature upsampling result into the first convolution layer for convolution processing, to obtain a style sub-feature;
inputting the style sub-feature into the first upsampling module for upsampling, to obtain a style upsampling result; and
inputting the style upsampling result into the second convolution layer for convolution processing, to obtain the style feature.

8. The method according to claim 1, wherein performing style fusion processing on the style feature and the excitation feature, to obtain the fused voice feature comprises:
separately inputting the style feature and the excitation feature into a generator, and performing style fusion processing on the style feature and the excitation feature via the generator, to obtain the fused voice feature.

9. The method according to claim 8, wherein the generator comprises a second upsampling module, a style fusion module, a gating module, and a third convolution module; and
performing style fusion processing on the style feature and the excitation feature via the generator, to obtain the fused voice feature comprises:
performing upsampling processing on the excitation feature via the second upsampling module, to obtain a first signal feature;
performing linear modulation on the first signal feature and the style feature via the style fusion module, to obtain a second signal feature, and processing the second signal feature via the gating module, to obtain a third signal feature; and
performing convolution processing on the third signal feature via the third convolution module, to obtain the fused voice feature.

10. The method according to claim 9, wherein the style fusion module comprises a first style fusion submodule and a second style fusion submodule;
the gating module comprises a first gating submodule and a second gating submodule; and
performing linear modulation on the first signal feature and the style feature via the style fusion module, to obtain the second signal feature, and processing the second signal feature via the gating module, to obtain the third signal feature comprise:
performing linear modulation on the first signal feature and the style feature via the first style fusion submodule, to obtain a first modulation result;
processing the first modulation result via the first gating submodule, to obtain a first gating result;
performing linear modulation on the first gating result and the style feature via the second style fusion submodule, to obtain a second modulation result; and
processing the second modulation result via the second gating submodule, to obtain the third signal feature.

11. The method according to claim 1, wherein the method further comprises:
inputting the decoded voice signal and the original voice signal into a discriminator, and recognizing the decoded voice signal and the original voice signal via the discriminator.

12. An electronic device, comprising:
a memory and a processor, wherein the memory is coupled to the processor; and
the memory stores program instructions, and when the program instructions are executed by the processor, the electronic device is enabled to:
obtain an acoustic feature encoding result in an encoded bitstream;
obtain style feature from the acoustic feature encoding result, wherein the style feature indicates a voice style of an original voice signal;
in response to an obtained excitation feature, perform style fusion processing on the style feature and the excitation feature to obtain a fused voice feature; and
generate a decoded voice signal based on the fused voice feature.

13. The electronic device according to claim 12, wherein the electronic device is further enabled to:
obtain the excitation feature via an excitation network.

14. The electronic device according to claim 13, wherein the excitation network comprises an excitation signal generation model and a first convolution module; and
the electronic device is further enabled to:
generate an excitation signal via the excitation signal generation model; and
perform convolution processing on the excitation signal via the first convolution module, to obtain the excitation feature.

15. The electronic device according to claim 14, wherein the excitation network further comprises a short-time Fourier transform module, the electronic device is further enabled to:
extract a time-frequency domain feature from the excitation signal via the short-time Fourier transform module; and
perform convolution processing on the time-frequency domain feature via the first convolution module.

16. The electronic device according to claim 12, wherein the electronic device is further enabled to:
obtain the style feature from the acoustic feature encoding result via a style network.

17. The electronic device according to claim 16, wherein the style network comprises a first upsampling module and a second convolution module, and the electronic device is further enabled to:
perform upsampling on the acoustic feature encoding result via the first upsampling module, to obtain an acoustic feature upsampling result; and
perform convolution processing on the acoustic feature upsampling result via the second convolution module, to obtain the style feature.

18. The electronic device according to claim 17, wherein the style network comprises a first upsampling module, a first convolution layer, and a second convolution layer; and the electronic device is further enabled to:
perform upsampling on the acoustic feature encoding result via the first upsampling module, to obtain an acoustic feature upsampling result;
input the acoustic feature upsampling result into the first convolution layer for convolution processing, to obtain a style sub-feature;
input the style sub-feature into the first upsampling module for upsampling, to obtain a style upsampling result; and
input the style upsampling result into the second convolution layer for convolution processing, to obtain the style feature.

19. The electronic device according to claim 12, wherein the electronic device is further enabled to:
separately input the style feature and the excitation feature into a generator, and perform style fusion processing on the style feature and the excitation feature via the generator, to obtain the fused voice feature.

20. A computer-readable storage medium, wherein the computer-readable storage medium stores a computer program, and when the computer program is run on a computer or a processor, the computer or the processor is enabled to:
obtain an acoustic feature encoding result in an encoded bitstream;
obtain style feature from the acoustic feature encoding result, wherein the style feature indicates a voice style of an original voice signal;
in response to an obtained excitation feature, perform style fusion processing on the style feature and the excitation feature to obtain a fused voice feature; and
generate a decoded voice signal based on the fused voice feature.
